(19) United States
(12) Patent Application Publication
(10) Pub. No.: US 2026/0269144 A1
(43) Pub. Date: Sep. 10, 2026

(54) CAPACITOR AND ELECTRODE ACTIVE MATERIAL

(71) Applicant: Panasonic Intellectual Property Management Co., Ltd., Osaka (JP)

(72) Inventors: CHIHO NOBUMORI, Hyogo (JP); YUKIHIRO SHIMASAKI, Hyogo (JP)

(21) Appl. No.: 19/165,346

(22) PCT Filed: Feb. 19, 2024
(86) PCT No.: PCT/JP2024/005845

§ 371 Date: Sep. 15, 2025

(30) Foreign Application Priority Data
Mar. 30, 2023 (JP) 2023-055414

(51) Int. Cl. H01G 11/24; H01G 11/28; H01G 11/34; H01G 11/36; H01G 11/60

(52) U.S. Cl. CPC H01G 11/24; H01G 11/28; H01G 11/34; H01G 11/36; H01G 11/60

(57) ABSTRACT

The capacitor includes: a first electrode, a second electrode, and an electrolytic solution. At least one of the first electrode and the second electrode is an electrode containing a nitrogen-containing carbon material. The nitrogen-containing carbon material contains a six-membered ring, and the six-membered ring includes at least one of: one or more carbonyl carbons; and two or more nitrogen atoms.

### TECHNICAL FIELD

The present disclosure relates to a capacitor and an electrode active material.

### BACKGROUND ART

PTL 1 proposes “an electrode material including a nitrogen-containing carbon foam having a nitrogen content of 2.5 to 30 wt % and obtained by carbonizing a melamine resin foam at a temperature of 600 to 1200° C. in an inert atmosphere”.

PTL 2 proposes “a nitrogen-containing carbon porous material having a nitrogen content of 0.5 to 30 mass % and a specific surface area of 200 to 3000 m²/g”, describing that the nitrogen-containing carbon porous material is “obtained by mixing melamine and magnesium citrate, heating the same to 700° C. or higher in an inert atmosphere, and then cooling and acid-washing the same”.

PTL 3 proposes “a method for producing a carbon material, the method including: a step of encapsulating a guest substance in pores of an organic covalent bond framework; and a step of heating the organic covalent bond framework encapsulating the guest substance for carbonization”.

### CITATION LIST

### Patent Literature

PTL 1: Unexamined Japanese Patent Publication No. 2007-269505
PTL 2: International Publication No. WO 2011/065484
PTL 3: International Publication No. WO 2020/175616

### SUMMARY OF THE INVENTION

One aspect of the present disclosure relates to a capacitor. The capacitor includes: a first electrode, a second electrode, and an electrolytic solution. At least one of the first electrode and the second electrode is an electrode containing a nitrogen-containing carbon material. The nitrogen-containing carbon material contains a six-membered ring, and the six-membered ring includes at least one of: one or more carbonyl carbons; and two or more nitrogen atoms.

Another aspect of the present disclosure relates to a capacitor. The capacitor includes: a first electrode, a second electrode, and an electrolytic solution. At least one of the first electrode and the second electrode is an electrode containing a nitrogen-containing carbon material. The nitrogen-containing carbon material has a differential pore volume distribution A that has a first peak in a range of 1.0 nm or more and less than 2.0 nm.

Still another aspect of the present disclosure relates to an electrode active material. The electrode active material contains a nitrogen-containing carbon material. The nitrogen-containing carbon material contains a six-membered ring, and the six-membered ring includes at least one of: one or more carbonyl carbons; and two or more nitrogen atoms.

Still another aspect of the present disclosure relates to an electrode active material. The electrode active material contains a nitrogen-containing carbon material. The nitrogen-containing carbon material has a differential pore volume distribution A that has a first peak in a range of 1.0 nm or more and less than 2.0 nm.

According to the present disclosure, it is possible to obtain a capacitor capable of achieving both initial capacity and reliability.

### BRIEF DESCRIPTION OF THE DRAWINGS

FIG. 1 is a partially cutaway perspective view of an electric double layer capacitor using an organic electrolytic solution according to the present disclosure.

FIG. 2 is a diagram illustrating the differential pore volume distribution of a nitrogen-containing carbon material.

FIG. 3 is a diagram illustrating the Log differential pore volume distribution of a capacitor electrode containing a nitrogen-containing carbon material.

### DESCRIPTION OF EMBODIMENT

PTLs 1 to 3 propose an electrode material containing nitrogen. The electrode material containing nitrogen can exhibit a high capacity. However, the capacity is usually partially a pseudo-capacity accompanied by a Faraday reaction. When a material is highly reliable in an electric double layer capacitor using an aqueous electrolyte, the material has a trade-off relationship between the initial capacity and the reliability in an electric double layer capacitor using an organic electrolytic solution. It is considered that an electric double layer capacitor using an organic electrolytic solution is charged up to a high voltage of, for example, 3 V or more, and therefore the active species of the pseudo-capacity easily deteriorate.

Hereinafter, the exemplary embodiments of the present disclosure will be described with reference to examples, but the present disclosure is not limited to examples to be described below. Although specific numerical values and materials are sometimes provided as examples in the description below, other numerical values and materials may be used as long as the effect of the present disclosure can be achieved. In the present description, the description “numerical value A to numerical value B” includes the numerical value A and the numerical value B, and can be read as “between numerical value A and numerical value B, inclusive”. In description below, in a case where lower limits and upper limits of numerical values related to specific physical properties, conditions, or the like are illustrated, any of the illustrated lower limits and any of the illustrated upper limits can be optionally combined unless the lower limit is more than or equal to the upper limit. In a case where a plurality of materials are illustrated, one type of the materials may be selected and used alone, or two or more types of the materials may be used in combination.

The capacitor of the present disclosure (hereinafter, also referred to as “capacitor (NC)”) includes a first electrode, a second electrode, and an electrolytic solution. The “capacitor” may be read as “condenser”. The capacitor means, for example, a power storage device such as an electric double layer capacitor or a lithium ion capacitor.

At least one of the first electrode and the second electrode is an electrode containing a nitrogen-containing carbon material (hereinafter, also referred to as “carbon material (NC)”) according to the present disclosure as an electrode active material (hereinafter, also simply referred to as “active material”). The carbon material (NC) contains a six-membered ring having the characteristics described above or below (hereinafter, also referred to as “six-membered ring (NC)”), or has a differential pore volume distribution having the characteristics described above or below.

The six-membered ring (NC) includes one or more carbonyl carbons and/or two or more nitrogen atoms. The six-membered ring (NC) may include a carbon atom bonded to two nitrogen atoms. The six-membered ring (NC) may constitute a conjugated system in which all six atoms constituting the six-membered ring are involved. The six-membered ring (NC) may include both one or more carbonyl carbons and two or more nitrogen atoms. The six-membered ring including both carbonyl carbons and nitrogen atoms may be a six-membered ring including two or three carbonyl carbons and two or three nitrogen atoms. The six-membered ring may have a 1,3,5-trione ring, may have a triazine ring, or may have a structure including both a 1,3,5-trione ring and a triazine ring (for example, an isocyanuric ring). The six-membered ring may include at least one selected from the group consisting of an isocyanuric ring, a triazine ring, and a 1,3,5-trione ring.

The six-membered ring (NC) has a structure derived from a raw material of the carbon material (NC). The carbon material (NC) is produced by carbonizing the raw material at a high temperature. Therefore, the structure of the six-membered ring (NC) is sometimes not clearly detected. Even in such a case, the carbon material (NC) or the raw material thereof can be identified by measuring the differential pore volume distribution of the carbon material (NC) or an electrode produced using the carbon material (NC).

Hereinafter, the electrode containing the carbon material (NC) is also referred to as electrode (E). The electrode (E) may include an active layer and a current collector carrying the active layer. The current collector is not particularly limited, and a known current collector used for an electrode of an electrochemical device may be used.

### <Carbon Material (NC)>

The carbon material (NC) functions as an active material that exhibits capacity by doping and dedoping ions. The doping of ions to the carbon material (NC) is a concept including adsorption of ions to the carbon material (NC), occlusion of ions by the carbon material (NC), chemical interaction between the carbon material (NC) and ions, and the like. The dedoping of ions from the carbon material (NC) is a concept including desorption of ions from the carbon material (NC), release of ions from the carbon material (NC), release of chemical interaction between the carbon material (NC) and ions, and the like.

Here, the doping of ions to the carbon material (NC) mainly refers to adsorption of ions to the carbon material (NC), and the dedoping of ions from the carbon material (NC) mainly refers to desorption of ions from the carbon material (NC). When ions are adsorbed to the carbon material (NC), an electric double layer is formed to exhibit a capacity. That is, the electrode (E) is a polarizable electrode. However, the electrode (E) may be an electrode in which a Faraday reaction contributes to capacity.

The carbon material (NC) is suitable as an active material of an electric double layer capacitor including an organic electrolytic solution. The electric double layer capacitor including the carbon material (NC) and an organic electrolytic solution (hereinafter, also referred to as “EDLC (NC)”) can exhibit an excellent initial capacity. The EDLC (NC) may be low in low-temperature resistance. The EDLC (NC) has excellent reliability.

The six-membered ring (NC) is excellent in structural stability. It is considered that the excellent structural stability contributes to improvement of reliability of the EDLC (NC). It is considered that the nitrogen atom included in the six-membered ring (NC) contributes to exhibition of the excellent initial capacity of the EDLC (NC) or reduction of the low-temperature resistance. It is presumed that the presence of a carbon atom bonded to the two nitrogen atoms constituting the six-membered ring (NC) is involved in such contribution. It is considered that the carbon material (NC) not only easily exhibits a pseudo-capacity accompanied by a Faraday reaction, but also has high reversibility of such a pseudo-capacity.

The six-membered ring (NC) preferably includes, for example, an isocyanuric ring. The isocyanuric ring is excellent in structural stability. The isocyanuric ring includes three carbonyl carbon atoms each bonded to two nitrogen atoms. The isocyanuric ring is particularly stable in an environment where the amount of water or a protic solvent is low.

The six-membered ring (NC) preferably includes, for example, a triazine ring. The triazine ring is excellent in structural stability. The triazine ring includes three carbon atoms each bonded to two nitrogen atoms. The triazine ring is particularly stable in an environment where the amount of water or a protic solvent is low.

On the six-membered ring (NC), an aromatic ring may be directly bonded as a substituent. The aromatic ring as a substituent may be bonded to each of the 1, 3, and 5-positions of the six-membered ring (NC). The aromatic ring as a substituent may be a phenyl group. Such a phenyl group may further have a substituent. The substituent bonded to the phenyl group may be a C1 to C6 alkyl group such as a methyl group, an ethyl group, or a propyl group, a C1 to C6 alkenyl group, or the like.

The carbon material (NC) may further contain a 1,3,5-trione ring (hereinafter, also referred to as “trione ring”). It is considered that the double-bond oxygen included in the trione ring contributes to exhibition of the excellent initial capacity of the EDLC (NC) or reduction of the low-temperature resistance. The trione ring is excellent in structural stability, and particularly stable in an environment where the amount of water or a protic solvent is low.

Since an isocyanuric ring includes three carbon atoms each bonded to two nitrogen atoms and also belongs to a trione ring, the carbon material (NC) containing an isocyanuric ring is promising as an active material.

The carbon material (NC) has a nitrogen content C_{N} of, for example, preferably 2 mass % or more, and more preferably between 4 mass % and 20 mass %, inclusive. In this case, since the content of the six-membered ring including two or more nitrogen atoms is sufficiently high, a high capacity can be expected. The structural stability of the carbon material (NC) is also sufficiently enhanced.

The carbon material (NC) has an oxygen content C_{OX} of, for example, preferably 6 mass % or more, and more preferably between 8 mass % and 18 mass %, inclusive. In this case, since the content of trione rings is sufficiently high, a high capacity can be expected. The structural stability of the carbon material (NC) is also sufficiently enhanced.

The ratio of the oxygen content C_{OX} with respect to the nitrogen content C_{N}: C_{OX}/C_{N} is preferably between 0.25 and 3.5, inclusive. In this case, the carbon material (NC) contains nitrogen atoms and oxygen atoms in a well-balanced manner.

The differential pore volume distribution (differential pore volume distribution A) of the carbon material (NC) may have a first peak in a range of 1.0 nm or more and less than 2.0 nm. The differential pore volume distribution of the carbon material (NC) may have a second peak in a range of 0.5 nm or more and less than 1.0 nm. The presence of such small pores is advantageous for the movement of ions inside the electrode.

The differential pore volume distribution of the carbon material (NC) may have a third peak in a range of 2.0 nm or more and less than 3.0 nm. The differential pore volume distribution of the carbon material (NC) may have a fourth peak in a range of 3.0 nm or more and less than 6.0 nm. The differential pore volume distribution of the carbon material (NC) may have a broad fifth peak in a range of 6.0 nm or more and less than 20 nm. When the third peak, the fourth peak, and the fifth peak are present in addition to the first peak and the second peak, the pore volume distribution becomes hierarchical, and an environment more advantageous for ion movement is formed.

However, the frequency of the first peak is preferably larger than the frequency of the second peak, and is preferably at least two times or more, or three times or more, the frequency of the second peak. Similarly, the frequency of the first peak is preferably larger than the frequency of the third peak, and is preferably at least two times or more, or three times or more, the frequency of the third peak.

In the differential pore volume distribution of the carbon material (NC), the total pore volume in a range of 20 nm or less is preferably 0.6 cm³/g to 1.4 cm³/g. In this case, an environment more advantageous for ion movement is formed.

The reliability of the capacitor (NC) can be evaluated by, for example, a float charge test in which a predetermined voltage is constantly applied to the capacitor at a high temperature of about 60° C. The reliability of the capacitor can be determined from the capacity retention rate and the resistance increase rate from the initial state of the capacitor when float charge is continuously performed over a predetermined time. The higher the capacity retention rate, and the smaller the resistance increase rate, the higher the reliability.

It is considered that the improvement of the reliability of the capacitor (NC) is related to the pore volume distribution of the carbon material (NC). For example, in the differential pore volume distribution of the carbon material (NC), the presence of mesopores having a pore size of 20 nm or less contributes to improvement of ion diffusion properties. When the carbon material (NC) contains micropores, mesopores, and macropores hierarchically in a well-balanced manner, ion diffusion properties are remarkably enhanced.

The reliability of the capacitor (NC) is also affected by the volume distribution of the macropores in the differential pore volume distribution of the electrode containing the carbon material (NC). For example, it is considered that macropores in a range of between 0.1 μm and 3 μm, inclusive greatly affect ion diffusion properties. The Log differential pore volume distribution (Log differential pore volume distribution B) of the electrode containing the carbon material (NC) may have a broad peak in a range of between 0.1 and 3 μm, inclusive. Thereby, together with the micropores and mesopores of the differential pore volume distribution, the carbon material (NC) has a hierarchical pore distribution, and forms an environment more advantageous for ion movement.

The differential pore volume distribution (differential pore volume distribution A) of the carbon material (NC) is determined, for example, by measuring an adsorption isotherm by a gas adsorption method using nitrogen gas, and analyzing the adsorption isotherm by the BJH (Barrett Joyner Hallenda) method or the DFT (Density Functional Theory) method. The total pore volume is an integrated value of the pore volume in the pore volume distribution obtained by analysis with the BJH method.

When the electrode containing the carbon material (NC) is a sample taken out from the capacitor, the sample is immersed in a highly volatile solvent (for example, dimethyl carbonate), washed under a reduced pressure of less than 0.1 MPa, and dried under a reduced pressure of less than 0.1 MPa for 2 hours or more. The drying may be performed, for example, at room temperature.

The pore volume distribution of the carbon material (NC) can be measured using, for example, a BELSORP 28SA apparatus available from BEL JAPAN, Inc. As the analysis theory of mesopores, the Dollimore Heal method (DH method) can be used, calculating based on the capillary condensation theory (Kelvin's equation). The pore volume distribution of micropores can be analyzed using the MP method (R. SH. MICHAIL et al., J. Coll. Inter. Sci., 26 (1968) 45). In the MP method, pores are assumed to have a slit shape, and the total of the pore volume having a slit width can be obtained as a function of the slit width. The pore volume distribution may be calculated using the DFT method. The DFT method is one of methods called molecular dynamics simulation method, and is a method for analyzing an adsorption phenomenon from a statistical and thermodynamic theory at the molecular level. As the device, an autosorb-iQ device manufactured by Anton Paar GmbH can be used.

The Log differential pore volume distribution (Log differential pore volume distribution B) of the electrode may be measured using a mercury porosimeter, for example, in accordance with “Test methods for pore size distribution of fine ceramic green body by mercury porosimetry” according to JIS R1655:2003. In the mercury porosimeter, mercury flows into the pores of a sample of the electrode under a reduced pressure state to measure pores having a large size, and then mercury penetrates deeper into the pores under a high pressure state. In the reduced pressure state, the pressure is reduced to about 50 μmHg with a vacuum pump. As an example of the method for flowing mercury into a sample, a cell that houses the sample and has an inflow hole for mercury is used. The sample is prepared, for example, as follows: an electrode having a current collector and an active layer (electrode layer) is formed in the same manner as in the examples, and a portion having the active layer (electrode layer) is cut out therefrom in a size of 20 mm×50 mm. In the high pressure state, the pressure is increased to about 230 MPa, and mercury is press-fitted into the sample.

The carbon material (NC) can be prepared or produced, for example, using a polyisocyanate as a raw material. The polyisocyanate preferably has an aromatic ring. In particular, toluene diisocyanate forms a crosslinked body having an isocyanuric ring through the trimerization reaction shown below.

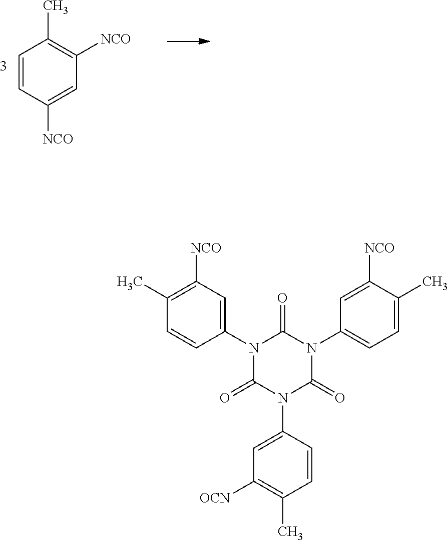

The isocyanuric ring of the crosslinked body of a polyisocyanate having an aromatic ring has an aromatic ring bonded to a nitrogen atom as a substituent. Such a crosslinked body is suitable as a raw material for the carbon material (NC) having excellent structural stability.

By adding a polyhydric alcohol to a polyisocyanate or toluene diisocyanate, a crosslinked body having excellent thermal decomposition properties (easily carbonized) can be produced. When the easily carbonized crosslinked body is heated under an inert atmosphere, a desired carbon material (NC) can be obtained at low cost.

The polyhydric alcohol preferably has a structure that easily forms a space between isocyanuric rings. Preferable examples thereof include glycerin, triglycerin, polyalkylene glycol, alkanediol (HO—(CH₂)ₙ—OH). The alkanediol (HO—(CH₂)ₙ—OH) may have a carbon number (n) of 2 to 10, for example. The isocyanate group and the alcoholic hydroxyl group react to form a urethane bond. A flexible linking group can be formed inside the crosslinked body via the urethane bond. For example, when an alkanediol is used, the linking group has a structure of —(CH₂)ₙ—.

The addition amount of the polyhydric alcohol to the polyisocyanate may be appropriately selected. The polyhydric alcohol may be added, for example, in an amount of 100 parts by mass to 1000 parts by mass, 200 parts by mass to 700 parts by mass, or 250 parts by mass to 500 parts by mass with respect to 100 parts by mass of the polyisocyanate. Since the polyisocyanate is expensive, it is preferable to increase the proportion of the polyhydric alcohol in terms of cost.

The inert atmosphere for carbonizing the crosslinked body is only a non-oxidizing atmosphere, and may be a decompressed atmosphere (for example, 0.1 MPa or less (preferably 10 Pa or less)), a reducing atmosphere (for example, a hydrogen atmosphere of 0.01 MPa or less), an inert gas atmosphere (for example, circulating atmosphere of N₂, Ar, Ne, He, or the like), or the like.

The heating temperature of the crosslinked body in an inert atmosphere may be 800° C. or lower, or may be 750° C. or lower. When the heating temperature is higher than 800° C., the nitrogen content C_{N} of the carbon material (NC) tends to be low, or the six-membered ring including a carbonyl carbon and/or two or more nitrogen atoms tends to be decreased.

The heating time is appropriately selected depending on the heating condition, and may be, for example, about 0.5 to 5 hours.

### <Organic Electrolytic Solution>

The organic electrolytic solution contains a non-aqueous solvent and an organic salt dissolved in the non-aqueous solvent. The non-aqueous solvent means a solvent other than water, and includes an organic solvent. The organic salt is a salt in which at least one of the anion and the cation includes an organic substance. The concentration of the organic salt in the organic electrolytic solution may be, for example, 0.5 to 2.0 mol/L. The organic electrolytic solution has a wider potential window (withstand voltage) than the aqueous electrolytic solution, can achieve a higher withstand voltage, and greatly contributes to improvement in the energy density and the output density of the capacitor.

The non-aqueous solvent is preferably a high-boiling-point solvent. Examples of the solvent that can be used include lactones such as γ-butyrolactone, carbonates such as propylene carbonate, polyhydric alcohols such as ethylene glycol and propylene glycol, cyclic sulfones such as sulfolane, amides such as N-methylacetamide, N,N-dimethylformamide, and N-methyl-2-pyrrolidone, esters such as methyl acetate, ethers such as 1,4-dioxane, ketones such as methyl ethyl ketone, and formaldehyde. Among them, from the viewpoint of enhancing the structural stability of the carbon material (NC), an aprotic solvent is preferable, and 80 mass % or more of the non-aqueous solvent may be an aprotic solvent.

Examples of the organic salt in which the cation includes an organic substance include an onium salt such as a quaternary ammonium salt. Examples of the organic salt in which the anion (or both ions) includes an organic substance include a salt of a carboxylic acid and an onium salt (onium carboxylate). Specific examples of the onium carboxylate include trimethylamine maleate, triethylamine borodisalicylate, ethyldimethylamine phthalate, mono-1,2,3,4-tetramethylimidazolinium phthalate, and mono-1,3-dimethyl-2-ethylimidazolinium phthalate. It is considered that such an organic salt increases the polarity of the organic electrolytic solution, contributes to improvement of wettability to the carbon material (NC), and has an action of increasing the pseudo-capacity by a redox reaction derived from a nitrogen atom contained in the organic salt. In addition, the organic salt can also have an action of increasing the carrier concentration at the interface between the carbon material (NC) and the organic electrolytic solution to improve the space charge capacity, an action of inducing charge bias within the carbon hexagonal network plane, and the like.

From the viewpoint of improving the withstand voltage characteristics, the anion preferably includes a fluorine atom, and for example, BF₄⁻ and/or PF₆⁻ is used. Specific examples of the preferred organic salt include a tetraalkylammonium salt such as ethyltrimethylammonium tetrafluoroborate and triethylmethylammonium tetrafluoroborate.

The organic electrolytic solution may contain a trace amount of water. However, from the viewpoint of enhancing the structural stability of the carbon material (NC), the water content in the organic electrolytic solution is preferably 50 ppm by mass or less.

### <Electrode (E)>

The electrode (E) may contain an optional component such as a binder and a conductive aid. The binder plays a role of assisting bonding between particles of the carbon material (NC) and bonding between a particle of the carbon material (NC) and the current collector.

Examples of the binder to be used include a fluororesin such as polytetrafluoroethylene (PTFE), polyvinylidene fluoride (PVdF), and a vinylidene fluoride-hexafluoropropylene copolymer (PVdF-HFP); and a water-soluble resin such as carboxymethyl cellulose (CMC), polyethylene oxide (PEO), polyethylene glycol (PEG), polyacrylonitrile (PAN), polymethyl methacrylate (PMMA), polyvinyl alcohol (PVA), polyvinyl pyrrolidone (PVP), polyacrylic acid (PAA), and polyvinyl acetate.

As the method for producing the electrode (E), for example, the carbon material (NC) and optional components (binder, conductive aid, and the like) are dispersed in a dispersion medium such as water to prepare a slurry. The obtained slurry is applied onto a current collector, and the coating film is dried to form an active layer (electrode layer) supported on the current collector, thereby obtaining the electrode (E). Thereafter, the active layer may be rolled.

As the current collector, a metal foil, a metal porous body, or the like can be used. As the material of the current collector, aluminum, copper, nickel, iron, stainless steel, platinum, or the like may be used. An alloy containing these metals as a main component may be used. The metal foil may be a plain foil, or may be a foil roughened by etching or the like, a foil subjected to plasma treatment, or the like. The metal porous body has, for example, a three-dimensional network structure.

### <Capacitor>

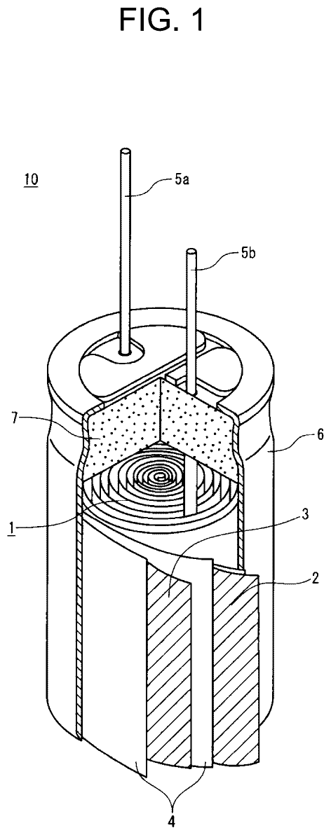

Next, an example of the capacitor including the electrode (E) will be described. FIG. 1 is a partially cutaway perspective view of an electric double layer capacitor (EDLC (NC)) having an organic electrolytic solution.

EDLC(NC) 10 in the illustrated example includes wound capacitor element 1. Capacitor element 1 has a structure in which first electrode 2 and second electrode 3, each of which is a sheet-like electrode (E), are wound with separator 4 interposed therebetween. First electrode 2 and second electrode 3 have a first current collector and a second current collector made of metal, respectively, and a first active layer and a second active layer, each of which contains a carbon material (NC), supported on the surface thereof, respectively, and exhibit a capacity by adsorbing and desorbing ions. For example, an aluminum foil is used as the first current collector and the second current collector. The surface of the current collector may be roughened by a method such as etching. As separator 4, for example, a nonwoven fabric containing cellulose as a main component is used. Lead wires 5a and 5b are connected as lead-out members to first electrode 2 and second electrode 3, respectively. Capacitor element 1 is housed in cylindrical outer case 6 together with an organic electrolytic solution (not shown). The material of outer case 6 may be, for example, metal such as aluminum, stainless steel, copper, iron, or brass. The opening of outer case 6 is sealed with sealing member 7. Lead wires 5a and 5b penetrate sealing member 7 and are led out to the outside. For sealing member 7, for example, a rubber material such as butyl rubber is used.

In the above exemplary embodiment, the wound capacitor has been described, but the application range of the present disclosure is not limited to the above, and the present disclosure can also be applied to a capacitor having another structure, for example, a stacked capacitor or a coin capacitor.

Hereinafter, the present disclosure will be described in more detail based on examples, but the present disclosure is not limited to the examples.

### Example 1

A wound electric double layer capacitor having a rated voltage of 2.8 V was produced. Hereinafter, a specific method for producing the electric double layer capacitor will be described.

### (1) Synthesis of Carbon Material (NC)

To 50 parts by mass of 2,4-toluene diisocyanate, 50 parts by mass of propanediol as an alkanediol was added, and the resulting mixture was allowed to stand at room temperature for 24 hours for curing to obtain a crosslinked body. The crosslinked body was heated at 700° C. for 0.5 hours under a nitrogen atmosphere to synthesize a carbon material (NC1).

The carbon material (NC1) was subjected to structural analysis by Fourier transform infrared spectroscopy (FT-IR) and X-ray photoelectron spectroscopy (XPS) in combination. It was confirmed that there were a C—O bond, a C—O—C bond, a C═O bond, a C═N bond, a C—N bond, and the like. It was inferred that the carbon material (NC1) contains an isocyanuric ring as a main component.

The carbon material (NC1) was subjected to XPS analysis. The nitrogen content C_{N} was 12.1 mass %, the oxygen content C_{OX} was 4.3 mass %, and the ratio of the oxygen content C_{OX} with respect to the nitrogen content C_{N}: C_{OX}/C_{N} was 0.35. Determined in accordance with JIS M8813:2004, the nitrogen content C_{N} was 15.9 mass %, the oxygen content C_{OX} was 6.3 mass %, and the C_{OX}/C_{N} was 0.4. As the analyzer, an oxygen/nitrogen/hydrogen analyzer (EGMA-830 manufactured by HORIBA, Ltd.) was used.

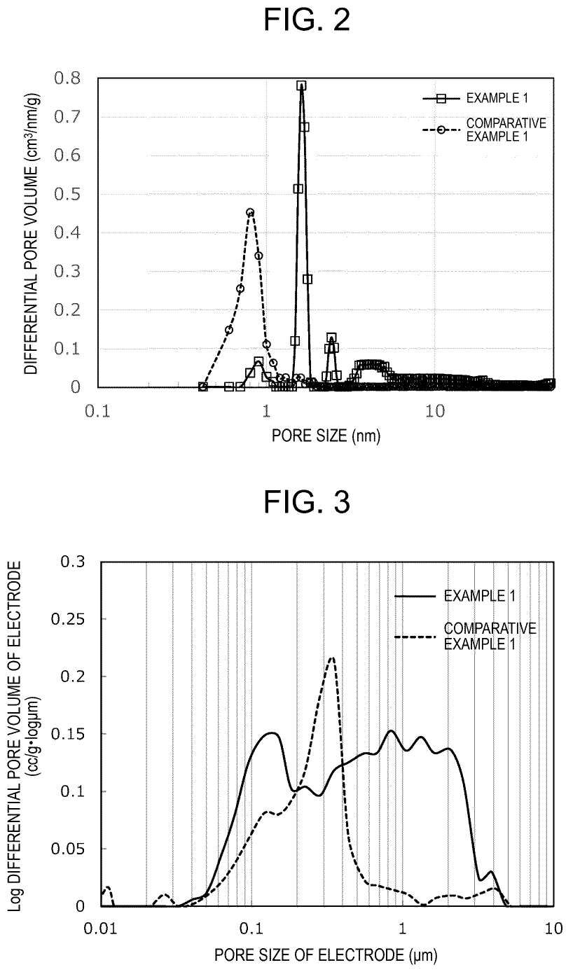

FIG. 2 shows the results of measuring the differential pore volume distribution of the carbon material (NC1) by the method described above. In FIG. 2, a first peak can be observed in a range of 1.0 nm or more and less than 2 nm, a second peak can be observed in a range of 0.5 nm or more and less than 1.0 nm, a third peak can be observed in a range of 2.0 nm or more and less than 3.0 nm, a fourth peak can be observed in a range of 3.0 nm or more and less than 6.0 nm, and a broad fifth peak can be observed in a range of 6.0 nm or more and less than 20 nm. The total pore volume in a range of 20 nm or less described above was 0.95 cm³/g.

### (2) Preparation of Electrode (E)

A slurry was prepared by dispersing 100 parts by mass of the carbon material (NC1) as an active material and 10 parts by mass of CMC as a binder in an appropriate amount of water. The obtained slurry was applied onto a current collector made of an Al foil and having a thickness of 30 μm, and the coating film was vacuum-dried at 110° C. and rolled to form an active layer, thereby obtaining an electrode (E).

FIG. 3 shows the results of measuring the Log differential pore volume distribution of the electrode (E) by the method described above. In FIG. 3, a broad peak is observed in a range of between 0.1 μm and 3 μm, inclusive.

### (3) Preparation of Organic Electrolytic Solution

Triethylmethylammonium tetrafluoroborate as an organic salt was dissolved in propylene carbonate as a non-aqueous solvent at a concentration of 1.0 mol/L to prepare an organic electrolytic solution.

### (4) Preparation of EDLC(NC)

A pair of electrodes (E) was prepared, lead wires were connected to the electrodes, and the electrodes were wound with a separator made of a cellulose nonwoven fabric interposed therebetween to form a capacitor element. The capacitor element was housed in a predetermined outer case together with an organic electrolytic solution, and the case was sealed with a sealing member to complete capacitor A1 of Example 1. Thereafter, an aging treatment was performed at 60° C. for 6 hours while a rated voltage of 2.5 V was applied.

### Comparative Example 1

A pair of electrodes was produced to produce capacitor B1 of Comparative Example 1 in the same manner as in Example 1 except that a general-purpose alkali-activated carbon (“activated carbon (CE1)”) was used as an active material.

The activated carbon (CE1) was analyzed by FT-IR and XPS, and no peak regarding nitrogen was detected.

In the activated carbon (CE1), the nitrogen content C_{N} was 0.07 mass %, the oxygen content C_{OX} was 4.08 mass %, and the ratio of the oxygen content C_{OX} with respect to the nitrogen content C_{N}: C_{OX}/C_{N} was 58.

As a result of measuring the differential pore volume distribution of the activated carbon (CE1) by the method described above, only a sharp peak was observed in a range of 0.5 nm or more and less than 1.0 nm. In the Log differential pore volume distribution of the electrode produced using the activated carbon (CE1), a broad peak as observed in the Log differential pore volume distribution of the electrode (E) was not observed, and the frequency sharply decreased in 0.5 μm or more.

### [Evaluation]

### <Initial Capacity>

Under an environment of −30° C., constant current charge was performed at a current of 100 mA/g until the voltage reached 2.8 V, and then the state in which a voltage of 2.8 V was applied was maintained for 7 minutes. Thereafter, constant current discharge was performed at a current of 100 mA/g under an environment of −30° C. until the voltage reached 0 V.

Time t (sec) required for the voltage to drop from 2.24 V to 1.12 V in the discharge was measured. Note that 2.24 V is a voltage corresponding to 80% of 2.8 V (voltage at full charge), and 1.12 V is a voltage corresponding to 40% of 2.8 V. Using measured time t, initial capacity C1 (F) of the capacitor before the float charge test was determined from Formula (A) below.

$$Capacity C 1 = Id \times t / Δ V 1 \qquad ( A )$$

In Formula (A), Id is a current value calculated from 100 mA/g and an active material amount (g), and ΔV1 is a value obtained by subtracting 1.12 V from 2.24 V.

### <Initial Resistance>

Using a discharge curve (vertical axis: discharge voltage, horizontal axis: discharge time) obtained by the above discharge, a linear approximate line of the discharge curve in the range from 0.5 seconds to 2 seconds after the start of discharge was obtained, and voltage VS of the intercept of the linear approximate line was determined. Voltage VS is subtracted from voltage V0, which is at the start of discharge (when 0 second has elapsed from the start of discharge), to determine a value (V0−VS) as ΔV2. Using ΔV2 (V) and current value Id during discharge (a current value calculated from 100 mA/g and an active material amount (g)), internal resistance (DCR) R1(Ω) of the capacitor before the float charge test was determined from Formula (B) below.

$$Internal resistance R 1 = Δ V / Id \qquad ( B )$$

### <Float Charge Test>

Under an environment of 60° C., constant current charge was performed at a current of 100 mA/g until the voltage reached 2.8 V, and then the voltage of 2.8 V was held for 1000 hours. In this way, the capacitor was stored in a state where the voltage of 2.8 V was applied thereto. Thereafter, constant current discharge was performed at a current of 100 mA/g under an environment of 60° C. until the voltage reached 0 V.

Thereafter, the capacitor was charged and discharged under an environment of −30° C. in the same manner as in the measurement of the capacity and internal resistance before the float charge test. Then, capacity C2 (F) and internal resistance R2(Ω) after the float charge test were determined.

The capacity retention rate and the resistance increase rate of the capacitor with respect to the initial state were measured. The capacity retention rate is a relative value of the capacity after the float charge test when the initial capacity is 100%. The resistance increase rate is a relative value of the low-temperature resistance after the float charge test when the initial low-temperature resistance is 100%.

TABLE 1

| | Initial state | | After float charge test | | Capacity | Resistance |
|---|---|---|---|---|---|---|
| | | Internal | | Internal | retention | increase |
| Characteristics | Capacity | resistance | Capacity | resistance | rate | rate |
| at −30° C. | (F) | (Ω) | (F) | (Ω) | (%) | (%) |
| Carbon material | 75 | 15.8 | 60.4 | 26.1 | 80.5 | 165 |
| (NC1) | | | | | | |
| Activated carbon | 57 | 35 | 26.3 | 165 | 46.1 | 471 |
| (CE1) | | | | | | |

The results in Table 1 show that when the carbon material (NC) is used as an active material, a capacitor capable of achieving both initial capacity and reliability is obtained.

### INDUSTRIAL APPLICABILITY

According to the present disclosure, a capacitor (for example, an electric double layer capacitor) capable of achieving both initial capacity and reliability is obtained.

### REFERENCE MARKS IN THE DRAWINGS

1 capacitor element
2 first electrode
3 second electrode
4 separator
5a first lead wire
5b second lead wire
6 outer case
7 sealing member
10 capacitor

1. A capacitor comprising:
a first electrode;
a second electrode; and
an electrolytic solution, wherein
at least one of the first electrode and the second electrode is an electrode containing a nitrogen-containing carbon material,
the nitrogen-containing carbon material contains a six-membered ring, and
the six-membered ring includes at least one of: one or more carbonyl carbons;
or two or more nitrogen atoms.

2. The capacitor according to claim 1, wherein the six-membered ring includes at least one selected from the group consisting of an isocyanuric ring, a triazine ring, and a 1,3,5-trione ring.

3. A capacitor comprising:
a first electrode
a second electrode; and
an electrolytic solution, wherein
at least one of the first electrode and the second electrode is an electrode containing a nitrogen-containing carbon material, and
the nitrogen-containing carbon material has a differential pore volume distribution A that has a first peak in a range of 1.0 nm or more and less than 2.0 nm.

4. The capacitor according to claim 3, wherein the nitrogen-containing carbon material has a differential pore volume distribution A that has a second peak in a range of 0.5 nm or more and less than 1.0 nm.

5. The capacitor according to claim 3, wherein the nitrogen-containing carbon material has a differential pore volume distribution A that has a third peak in a range of 2.0 nm or more and less than 3.0 nm.

6. The capacitor according to claim 3, wherein the nitrogen-containing carbon material has a differential pore volume distribution A that has a fourth peak in a range of 3.0 nm or more and less than 6.0 nm.

7. The capacitor according to claim 3, wherein the nitrogen-containing carbon material has a differential pore volume distribution A that has a broad fifth peak in a range of 6.0 nm or more and less than 20 nm.

8. The capacitor according to claim 3, wherein
the nitrogen-containing carbon material contains a six-membered ring, and
the six-membered ring includes at least one of: one or more carbonyl carbons; and two or more nitrogen atoms.

9. The capacitor according to claim 1, wherein the electrode containing the nitrogen-containing carbon material has a Log differential pore volume distribution B that has a broad peak in a range of between 0.1 μm and 3 μm, inclusive.

10. The capacitor according to claim 1, wherein the nitrogen-containing carbon material has a nitrogen content C_{N} of 2 mass % or more.

11. The capacitor according to claim 10, wherein the nitrogen-containing carbon material has an oxygen content C_{OX} of 6 mass % or more.

12. The capacitor according to claim 11, wherein a ratio of the oxygen content C_{OX} with respect to the nitrogen content C_{N}: C_{OX}/C_{N} is between 0.25 and 3.5, inclusive.

13. The capacitor according to claim 1, wherein the electrolytic solution contains a non-aqueous solvent and an organic salt dissolved in the non-aqueous solvent.

14. The capacitor according to claim 1, wherein the electrolytic solution has a water content of 50 ppm by mass or less.

15. The capacitor according to claim 1, wherein 80 mass % or more of the non-aqueous solvent is an aprotic solvent.

16. An electrode active material Comprising a nitrogen-containing carbon material, wherein
the nitrogen-containing carbon material contains a six-membered ring, and
the six-membered ring includes at least one of: one or more carbonyl carbons; and two or more nitrogen atoms.

17. The electrode active material according to claim 16, wherein the six-membered ring includes at least one selected from the group consisting of an isocyanuric ring, a triazine ring, and a 1,3,5-trione ring.

18. An electrode active material comprising a nitrogen-containing carbon material, wherein
the nitrogen-containing carbon material has a differential pore volume distribution A that has a first peak in a range of 1.0 nm or more and less than 2.0 nm.

19. The electrode active material according to claim 18, wherein
the nitrogen-containing carbon material contains a six-membered ring, and
the six-membered ring includes at least one of: one or more carbonyl carbons; and two or more nitrogen atoms.

20. The electrode active material according to claim 16, wherein the nitrogen-containing carbon material has a nitrogen content C_{N} of 2 mass % or more.

21. The electrode active material according to claim 20, wherein the nitrogen-containing carbon material has an oxygen content C_{OX} of 6 mass % or more.

22. The electrode active material according to claim 21, wherein a ratio of the oxygen content C_{OX} with respect to the nitrogen content C_{N}: C_{OX}/C_{N} is between 0.25 and 3.5, inclusive.
